(19) United States
(12) Patent Application Publication
(10) Pub. No.: US 2008/0179902 A1
(43) Pub. Date: Jul. 31, 2008

(54) Pet waste retrieval system and method

(76) Inventors: Lisa S. Phillips, Virginia Beach, VA (US); Peter C. Phillips, Virginia Beach, VA (US)

Correspondence Address: Bradley D. Goldizen, One Columbus Center, Ste. 665, Virginia Beach, VA, 23462, US

(21) Appl. No.: 11/700,381

(22) Filed: Jan. 31, 2007

(51) Int. Cl. A01K 29/00

(52) U.S. Cl. 294/1.3

(57) ABSTRACT

A pet waste retrieval and storage system and associated method ensures sanitary collection, and subsequent storage in accompanying sealed plastic bags, without any waste material coming into direct contact with the user, device components, or other unintended surroundings. A pet waste retrieval and storage system includes a container of sufficient volume, an accompanying lid, lid attachment lanyard, with associated non-corrosive installation hardware, a fabric cover with fastening means for attachment to the container's outer surface diameter, and an elastic leash connecting lanyard.

There are no related patent applications.

This application did not receive federal research and development funding.

### BACKGROUND OF THE INVENTION

The present invention generally relates to a waste retrieval system and method for pet waste disposal. More particularly, the invention is directed towards a system that includes a sealable disposal device having a cover and that is detachably coupled to a lease. The system includes a scoop and disposable inner liner arranged within the disposal device for storing pet waste.

Excrement from domestic animals, more specifically dogs, presents itself as a problem for pet owners. There exists a need for a convenient, sanitary, state-of-the-art method for waste retrieval, containment and disposal. While pet owners enjoy the freedom of taking their pets out for regular exercise, proper handling of pet waste should not have to be an arduous task. Many states, cities and local municipalities have enacted ordinances that require pet owners to clean up after their pets. Moreover, people who have lawns adjacent to the streets should not have to be responsible for pet waste from other pet owners. In addition, city, state, or federal park officials can also be faced with the same cleanup dilemma. Additionally, pet owners should have a state of the art retrieval system in order to clean up waste created by their pets in their own yards or dwellings. Such an example would include a pet owner who keeps his pet in a fenced in a yard. While it may not be necessary to store pet waste in such an example, a pet owner can use those selected components that comprise the current invention to retrieve and dispose of the waste. Other examples where personnel benefit from the current invention includes facilities where animals are kept, such as veterinary hospitals, boarding kennels, and police K9 units.

The prior art has included many methods of dealing with pet waste. A traditional method includes simply picking the waste up with a napkin or such, and placing it in a bag until such time of disposal of the waste laden bag in a garbage container. A health hazard may exist any time pet waste is allowed to decompose openly. At the very least, flies and odor can be a nuisance to others as to the degree of where it exists. Garbage containers do not provide for proper disposal of open waste. Pet owners may be reluctant to take any action since it is a task that entails handling feces. In addition, the fecal material remains on any item it comes in contact with. One example includes when picking up feces with a napkin or paper towel. Another example includes a scoop or shovel. Those items become contaminated and make for the further problem of properly cleaning or disposing of the contaminated item. Traditional scoops and shovels are not designed to efficiently remove excrement in uneven, rocky, or grassy terrain. As will be outlined in upcoming detail, a saw tooth design of the present invention's scoop allows for the most efficient retrieval. Some prior art methods allow contamination of the containers in which the waste is kept. There exists the risk of the waste coming in contact with the pet owner's hands and clothing. Storage of plastic bags and retrieval items, such as napkins and scoops, can be bulky and cumbersome. The owner has to be cognizant of all the necessary items and where to store them before beginning an exercise routine of walking or a day's outing with his or her dog. Some items of the prior art are bulky, complex in design and do not provide for convenient carrying. The pet owner also has to carry the pet waste by awkward means while on an exercise journey. It is conceivable to understand that with all the undesired necessary items of prior art, the chore of carrying them, along with the waste itself, and the subsequent cleaning and restocking of the items, pet owners may not exercise their pets to the extent desired, or simply leave the waste unattended.

Another problem with prior art methods includes leakage. Some prior art containers are inherently unsuitable when subjected to the rigorous activity during an exercise journey with a pet. For example, some containers may open accidentally causing spillage of the waste from within. Some containers are no more than soft pouches and are not suited for the normal rough handling that may occur. Soft pouches can mash easily and possibly break a storage bag inside thus allowing for leakage. Additionally, prior art examples do not include the benefit of ensuring the prevention of human contact with the excrement during retrieval, storage and disposal. Inefficient sealing of retrieved pet waste can be an issue as well. The waste stored in an improperly sealed container can leak odors. One can imagine on a hot day the unpleasant foul odor from stored pet waste in an improperly designed or direct contact designed container.

Examples of such prior devices include, but are not limited to, those depicted in U.S. Pat. Nos. 3,446,525, 4,014,584, 4,179,145, 4,225,174, 5,350,208, 4,958,871, 6,199,737, 5,503,442, and 7,040,677.

While there have been several attempts to solving the problem of pet waste handling, none are as efficient as the current invention. The ideal method incorporated by the present invention includes an encapsulated retrieval method, a rugged storage system, combined with the utmost ease of use and cleanliness. There exists no need to clean any scoop or container. Also, the waste material has been sealed beforehand in a plastic bag that can be simply deposited into a garbage container without the concern of any lingering odor or presence of insects such as flies.

### SUMMARY OF THE INVENTION

The present invention discloses a system for the retrieval and temporary storage of domestic pet waste acquired during outings or walks with one's pet. A method for using the system is also disclosed. The system includes a rigid container having a recess that includes an opening that is sealed by a removable lid that is coupled to the rigid container via a lanyard. A washable cover couples the container to an animal leash, harness, belt, collar or the like.

The system comprises a molded container having at least one closable opening for providing access to a storage recess within the container. The storage recess includes an open area that is large enough to simultaneously accommodate several clean bags, at least one soiled bag filled with waste matter, and the scoop. The molded container is preferably a plastic cylindrical canister formed from a thermo set or thermoplastic material that may be formed, molded or extruded in a desired particular shape and preferably having a threaded opening which is closable. The various plastics used in creating the molded container may include one or more of polyvinyl chloride, polyethylene, polypropylene and polystyrene or or any other moldable material that may be formed in a unitary shape. Likewise, other components of the invention discussed hereinafter, such as a lid and its associated lanyard and a storable scoop, may be created and molded by using the aforementioned various plastics. The molded container must be lightweight and rigid to prevent a collapsing of the storage recess.

A removable lid includes complementary threads that seal the threaded opening to maintain contents within the molded container and prevent any escaping odors. A washable, removable cover includes various hook and loop securing straps for surrounding the molded container and coupling it to a leash, belt, animal harness collar or the like. An elastic band leash connecting lanyard may also be included for coupling the molded container to a handle end of a leash.

A storable scoop comprises plastic material having memory retaining properties and saw-tooth edges. The scoop is stashed within the molded container such that the edges of the scoop not having the saw-teeth are at the top and bottom of the container. The memory retaining properties of the scoop aid in storage and ease in use it by encouraging the radius of the scoop to tend to assume an open position when placed within the container. This allows the scoop to be stored along the interior surface of the storage container without wasting any space. Elastic straps are provided on one face of the scoop for securing it to the hand of the user. Unsoiled plastic bags are also stored within the molded container and are used for encapsulating and capturing waste matter. The size of the unsoiled plastic bag is large enough to accommodate the size of a user's hand, the size of the scoop and the size of any waste matter to be stored. The plastic bag must be of a grade that is durable enough to prevent piercing of the plastic bags by the saw-tooth edges of the scoop.

The molded container is rugged, compact and of sufficient capacity to permit the storage of the scoop, unused plastic waste storage bags, and retrieved pet excrement which is permanently bagged and sealed.

The removable lid is either screwed on, snapped on, or attached by similar means in order to close and seal the container, thereby retaining the aforementioned items and preventing any foul odors from escaping. Preferably, the removable lid is attached to the canister by means of a pre-molded flat plastic strip such that the lid will not be separated from the container when the lid is removed from the opening of the container. This strip serves the purpose of preventing loss or lid misplacement when the container is open. A non-corrosive rivet, or like fastener, connects one end of the strip to the center of the container lid. The other end of the strip is ring-shaped and is stretched and slipped over the container's lid fastening threads in the preferred embodiment. The invention incorporates proper attachment design provisions as to permit unscrewing, unsnapping, etc., without twisting or binding the attachment strip that couples the lid to the container.

The cover is constructed of a launderable, nylon or material similar in texture, water repellency, and durability. The cover is preferably attached to the container by fasteners that may comprise various integral hook and loop fastening strips. The cover can be beneficial in many ways. Aside from esthetic value with the possibility of many color choices, imprinted designs, and labeling, the cover can contain extra pockets for pet items such as medicines, etc. The cover contains a sewn-in elastic loop for connecting the device to the pet leash. The cover also serves as a protective and durable padding for the container which can be easily removed and washed should it become dirty during the pet exercise activity.

The accompanying scoop is used in conjunction with plastic bags to facilitate the waste retrieval process. The scoop is preferably fabricated from plastic sheet material having memory retaining qualities such as to retain the form of an arcuate or curved cylindrical shape. A diameter of the circular shape, when taken in plan from an end, is slightly less than the internal diameter of the container. This shape allows for efficient placement and storage of the scoop within the container. Moreover, the shape conveniently conforms to the user's hand for a more natural feel when picking up waste products. Elastic bands attached to the convex side of the scoop secure it to one's hand. A user simply slips her thumb between the scoop and one of the elastic bands and slides her fingers under the other elastic band such that the scoop is held in the user's hand. The scooping edges include a saw-tooth type design as to permit the most efficient retrieval of pet waste in grasses and on uneven surfaces. The saw-tooth design allows the scoop to access rocky terrain, grassy or uneven ground more efficiently. The saw-tooth edges act as a rake and get into uneven areas, thereby, retrieving more waste than a flat edge scooping device.

To facilitate the retrieval process, the container or canister lid is opened and a clean plastic bag is removed along with the scoop. The scoop is secured to the hand via the elastic bands as described above. The user then places his hand, with the attached scoop, inside the plastic bag. The user tucks a bottom of the plastic bag inside the concave section of the scoop. The waste is retrieved by closing the scoop over the excrement pile, with no waste coming into contact with the user's hand or scoop. It is noted that in the majority of cases, the entire retrieval can be accomplished in one scooping action. Once the waste is in the plastic bag lined scoop, the user simply grabs the upper edge of the bag opening and inverts the exterior and interior surfaces of the bag. This manner allows the hand and scoop to be removed, while still maintaining no waste contamination, simultaneously while encapsulating the excrement. The user then removes the scoop from the hand, secures the waste containing plastic bag by a closure device such as a plastic tie, or similar means, places the scoop back into the container, places the sealed waste in the container, and replaces the lid. The waste is now properly contained until such time of proper disposal.

### BRIEF DESCRIPTION OF THE DRAWINGS

FIG. 1 is a perspective view of the invention shown in the closed position.

FIG. 2 is a perspective view of the invention shown in the open position.

FIG. 3 is a perspective view of the canister shown in the closed position. The outer material cover is not shown in this view.

FIG. 4A is an elevation view of the outer or exterior side of the cover depicting the leash connecting lanyard along with various hook and loop strips for securing the cover to the canister and the leash.

FIG. 4B is an elevation view of the inner or interior side of the cover depicting the leash connecting lanyard along with various hook and loop strips.

FIG. 5A is an elevation view of the convex side of the scoop containing the elastic hand retention bands. The scoop is shown in a flattened position for clarity.

FIG. 5B is an elevation view of the concave side of the scoop. The scoop is shown in a flattened position for clarity.

FIG. 5C is a perspective end view showing the scoop and its memorized shape.

FIG. 6 is a plan view of the pre-molded retaining device, preferably comprising a flat plastic strip, used to preserve the lid to the canister when the lid is removed from atop the canister during use of the invention.

FIG. 7A is a perspective view of the user's hand containing the opened scoop taken from an end of the scoop. After removal of the scope from the canister, this is a step in performing a waste removal operation.

FIG. 7B is a perspective view of the user's hand containing the opened scoop along with an unused plastic bag that has been slipped over the hand and scoop.

FIG. 7C is a perspective view of the user's hand containing the scoop, and plastic bag, in progress of the waste retrieval process. The bag covered scoop is inserted over and around the waste.

FIG. 7D is a perspective view of the user's hand containing the closed scoop, plastic bag, and retrieved waste.

FIG. 7E is a perspective view of the user performing the inversion process of the plastic bag containing retrieved waste.

FIG. 7F is a perspective view of the retrieved waste sealed in the plastic bag, ready for storage in the canister.

FIG. 8 is an elevation, cross sectional, cut-away view of the closed canister containing the scoop and retrieved waste in the sealed plastic bag.

FIG. 9 is a plan view of the opened canister containing the scoop and retrieved waste in the sealed plastic bag. In addition, FIG. 9 shows an inside view of the attached lid.

FIG. 10 is a perspective view of a typical exercising scenario of a user and pet along with the present invention as attached to the pet's leash.

### DETAILED DESCRIPTION OF THE PREFERRED EMBODIMENTS

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

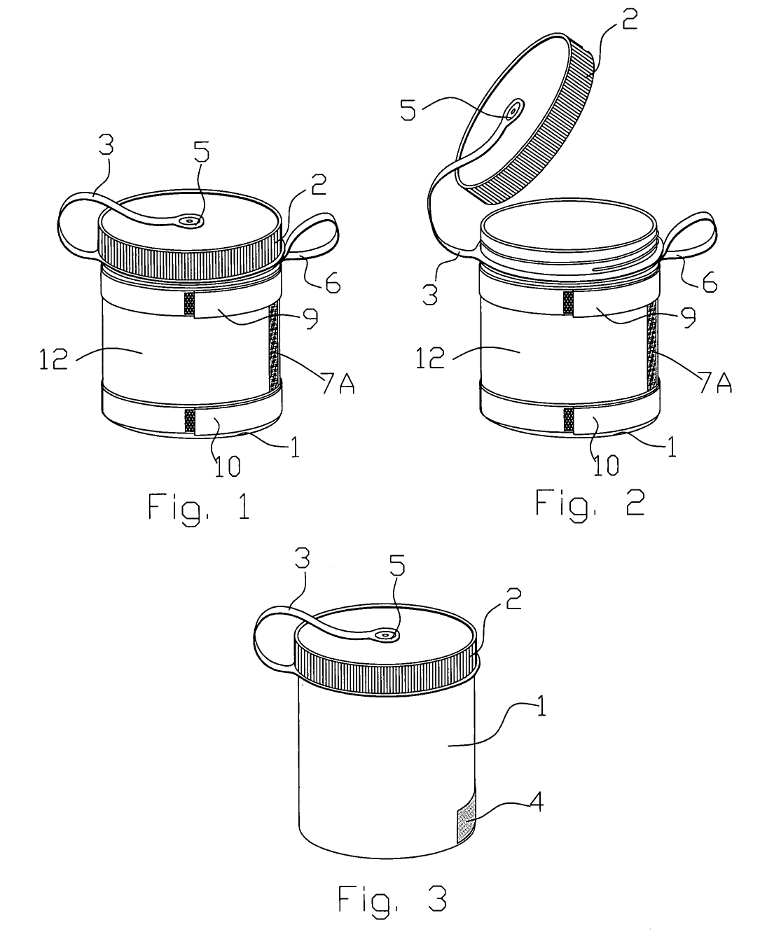

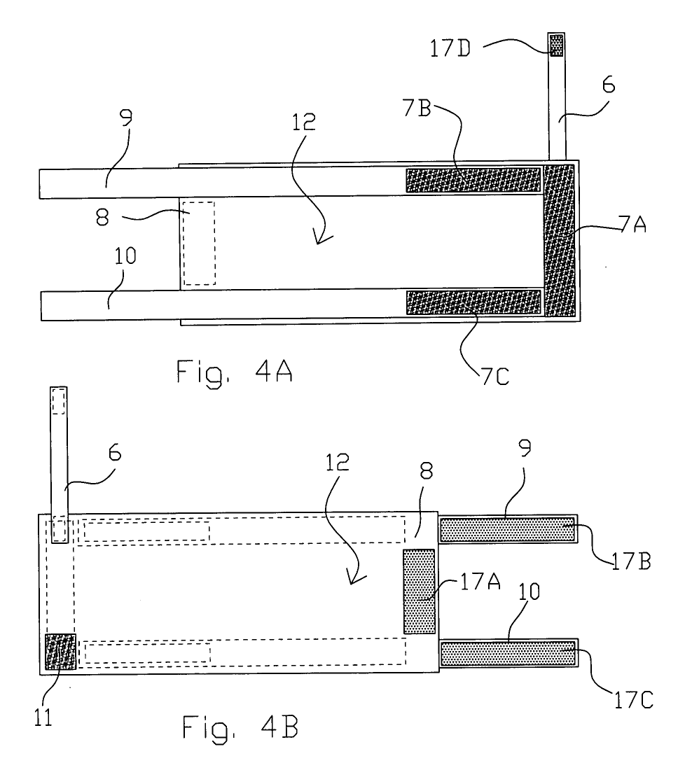

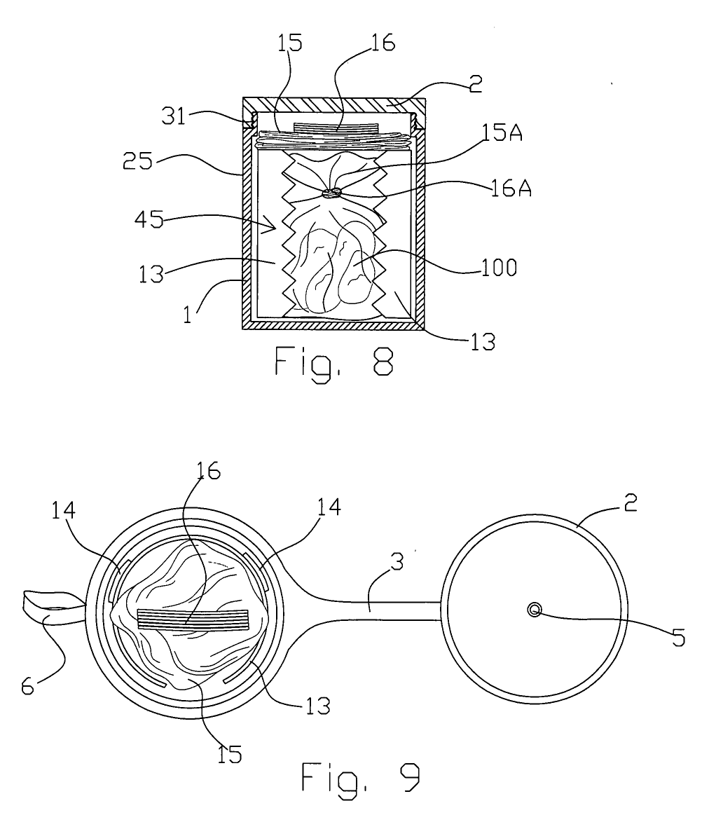

Referring now to the various views of FIGS. 1-3, the following is a discussion of the best mode of implementing the invention. FIGS. 1 and 2 are shown with cover 12 surrounding an exterior surface of canister 1. Views of the two sides of the cover 12 are shown in FIGS. 4A and 4B, and discussed herein below. FIG. 3 is shown without cover 12. The present invention is a system comprising a cylindrical canister 1 with an attached, removable lid 2. Lid 2 is also cylindrical and designed to mate with canister 1 by means of integral molded right hand internal threads (not shown). Canister 1 comprises a molded plastic sidewall 25 with an opening that includes preformed right hand external threads to mate with the internal threads of lid 2. External threads 31 are arranged about opening 33 that opens into a storage recess 45 (shown in FIG. 8). The material properties for canister 1 include durability and reduced weight. The preferred material properties of lid 2 are identical to canister 1. The wall of canister 1 and lid 2 are sufficient in thickness to prevent deformity while maintaining the pre-molded shape when subjected to the normal rugged handling that is experienced during use. Lid 2 contains knurling on the outer diameter for ease of gripping and increased friction between the lid and one's fingers to facilitate rotation of the lid 2 when screwing the lid 2 onto canister 1 or unscrewing the lid 2 from the canister 1.

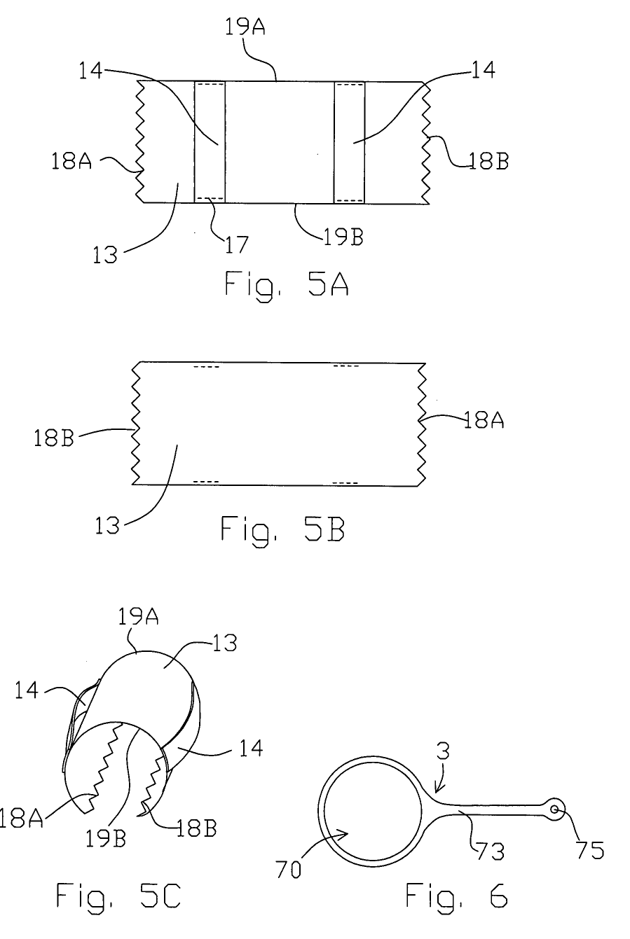

Lid 2 is attached to canister 1 by means of a molded, flat, plastic lid lanyard strip 3, more clearly shown in FIG. 6. Lid lanyard strip 3 is the preferred embodiment that serves for preventing loss or misplacement of lid 2 when unscrewed from canister 1. The lid lanyard strip 3 includes a large diameter opening 70 and a small diameter opening 75 connected together via a flexible flat strip 73. The large diameter opening is substantially equal to an outer diameter of the threads 31. The small diameter opening is substantially equal to an outer diameter of a fastener 5 arranged in the center of lid 2. The fastener 5 may be a non-corrosive rivet that connects one end of the lanyard strip 3 to preferably a center of lid 2. Rivet 5 is compressed in such a manner as to permit free rotation of lid 2 relative to lanyard strip 3 to forestall binding during rotational activity when screwing lid 2 onto canister 1, or unscrewing lid 2 from canister 1. The remaining opposite end of the lanyard strip 3 includes opening 70 which is stretched and slipped over fastening threads 31.

A cover securing pad 4 is attached to the sidewall 25 on the lower half of canister 1 by the preferred means of an adhesive back that is not shown in the drawings. Cover securing pad 4 is used, in part, to secure a cover 12 to an exterior surface of canister 1, facilitate alignment, and prevent slippage of the cover 12 about the exterior surface of the canister 1. The cover securing pad comprises one-half of a strip of hook and loop material. A complementary canister securing pad strip is sewn onto the inner side of the cover 12 in an area to correspond to the location of cover securing pad 4 and as shown in FIG. 4B.

The cover 12 is of nylon-like, rip-stop, durable material 8 and having various fastening complementary fastening strips denoted as 7A-C and 17A-D, which contribute to both the esthetic value and functional value of the invention. The various arranged cover elements allow the canister 1 to be attached to any small diameter or flat material such as a leash, belt, animal harness, collar or the like.

Connecting lanyard 6 is used to secure the invention to the handle end of the leash of the pet or other desired location. Preferably, the connecting lanyard 6 comprises an elastic material. One end of the connecting lanyard 6 is permanently fastened to the cover 12, which in turn, is securely fastened to canister 1 during use. An attachment pad 17D of preferably a hook and loop material is arranged on an opposite, free end of the connecting lanyard 6 and is of a complementary material that mates with strip 7A to fasten the two together. During use, connecting lanyard 6 is passed through a loop of material, such as the handle of a leash and shaped into a loop as shown in FIGS. 1, 2 and 10. A connection point created by overlapping attachment pad 13 to complementary fastening strip 7A is further reinforced by the placement of a first circumferential fastening strip 9 about the cover as shown in FIGS. 1 and 2. The connecting lanyard 6 is comprised of an elastic band material of sufficient strength as to withstand the continued shaking and vibration during the pet exercise journey. Moreover, the lanyard 6 contains a detachable end that utilizes the preferred means of hook and loop fastening for attachment and detachment from a pet's leash.

The cover 12 is wrapped around canister 1 and secured by an axial fastener created by the overlapping fastening strip 17A onto a portion of fastening strip 7A. Dual circumferential fasteners 9, 10 are arranged near an upper edge and a lower edge of the rectangular material 8. Each circumferential fastener preferably includes a strip of durable cloth material sewn along the entire length of the upper edge and the lower edge of material 8. The length of each strip is greater than the length of material 8. Fastening strips 17B and 17C are attached to an inner side of respective free ends of the circumferential fasteners 9, 10 and are overlapped onto respective fastening strips 7B and 7C. Specifically, hook and loop material is used as the preferred fastening means for all detachable couplings of the various parts of the cover 12.

Upon wrapping the cover 12 around the canister, each end of the covering containing the sewn in vertical loop material strip 7A and mating sewn in vertical hook material strip 17A, respectively, are aligned and subsequently pressed together to create an axial fastener that fastens the cover 12 onto canister 1. Similarly, the circumferential edges of the cover comprising the circumferential fasteners 9 and 10 are individual aligned, front to back, and pressed together. While vertical and horizontal fastening means have been described for the attachment of cover 12 to canister 1, there still remains the issue of axial and/or radial slippage. To prevent this undesired slippage, the preferred means of cover securing pad 4 is used in combination with the loop pad 11. Cover securing pad 4 is attached on the lower half of canister 1 by the preferred means of an adhesive back (not shown). Loop pad 11, as sewn onto the inner side of the canister's outer covering 12, mates with cover securing pad 4 during the wrapping process to create an attachment point between the exterior surface of the canister and the interior surface of the cover. In this manner, the free ends of the circumferential fasteners may be used to more securely fasten the system onto a leash or the like by using the axial fastener to initially secure the cover 12 about the canister 1 and thereafter arranging the cover against a strip of material such as a harness or leash and passing the free ends of the circumferential fasteners around the same strip of material and securing the free ends to the cover as discussed above. In this manner, the circumferential fasteners also fasten the cover to the leash or other such material. Preferably, the height of the cover is substantially equal to the height of the sidewall of the canister less any threads.

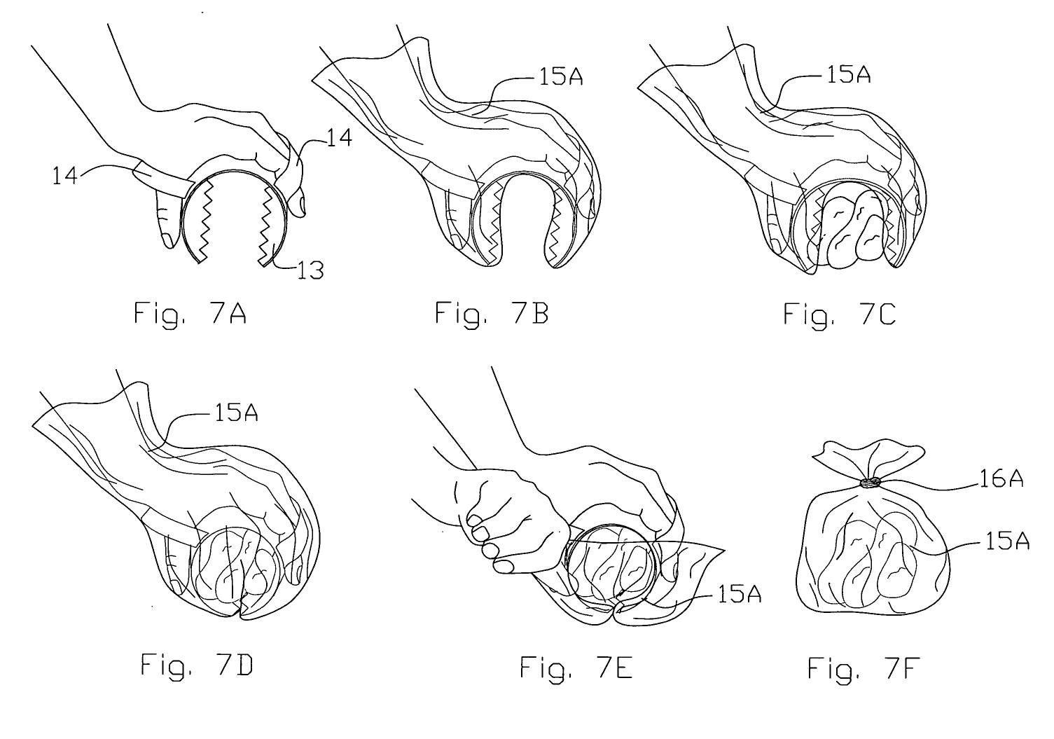

As shown in FIGS. 5A-5C, scoop 13 is used in retrieving pet excrement. The scoop is coupled to an interior of a user's hand via straps. The scoop is secured to the back of the user's hand by two elastic retention strips 14, as shown in FIG. 7A. Scoop 13 is a rectangular shaped plastic sheet of sufficient thickness with the appropriate elastomeric properties as to retain a memorized circular shape. This shape serves to minimize conflicting storage space in canister 1. When stored, the inherent shape of scoop 13 conforms to inner diameter of canister 1 as shown in FIGS. 5C, 8 and 9, thereby, allowing the remaining volume of the storage recess 45 to accommodate the retrieved waste as sealed in plastic bag 15A, extra unused storage bags 15, and tie-wraps 16. Saw-tooth edges 18A, 18B are provided on opposite ends of scoop 13. The two elastic retention strips 14 are preferably sewn onto an exterior surface of scoop 13. Scoop 13 also comprises an upper edge 19A and a lower edge 19B. The elastic retention strips are arranged parallel to edges 18A, 18B and between upper and lower edges 19A, 19B.

FIGS. 7A-7F show part of the process steps for using the present system. After the pet has deposited waste onto a surface, bag 15A and scoop 13 are retrieved from canister 1. During the waste retrieval process, and following attachment of scoop 13 via the elastic retention strips 14, as shown in FIG. 7A, a clean unused plastic bag 15A is slipped over the user's hand and “cupped” or preformed to the concave section of scoop 13 as shown in FIG. 7B. The user retrieves the waste by flattening out the hand which simultaneously opens the scoop 13. The user places the positioned flat extended hand and scoop over the waste, and then closes the hand and scoop as shown in FIG. 7C, and subsequently encompasses the waste as shown in FIG. 7D. The waste is isolated from the scoop by the plastic bag 15 in a manner similar to a glove or mitt. Upon receipt of the waste, the user grabs the plastic bag 15 by the opening edges and removes in a manner as one might remove an elastic medical exam glove, as shown in FIG. 7E. Upon removal, the waste is encapsulated in the plastic bag 15. The user then removes the scoop and seals the plastic bag by the preferred means of a tie-wrap 16A, as shown in FIG. 7F. The completion of the waste storage process includes placing the scoop and the sealed waste back into canister 1 to be stored as shown in FIG. 8. The lid 2 is then screwed back on canister 1 and the invention is returned to the pet leash by means of attachment of the leash connection lanyard 6. FIG. 9 is an overhead view showing the lid removed and the various parts of the system.

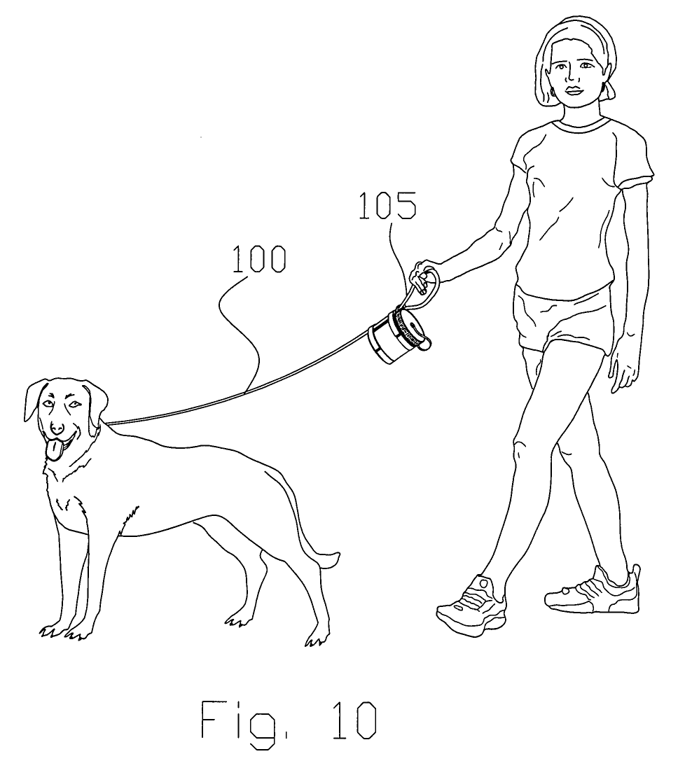

As shown in FIG. 10, a user can secure the system at a top end of a leash 100 as discussed previously. The connection lanyard 6 prevents the system from slipping down to the end of the leash attached to the dog. The circumferential fasteners couple the cover and canister onto the leash between the handle 105 and an opposite end coupled to the shown dog.

Having described the present invention with respect to the preferred embodiments and pursuant to the requirements of patent statues, the preferred embodiments can be modified, substituted or augmented in order to facilitate the ease of manufacture without deviating from the original scope or intent of the present invention. For example, a person skilled in the art may choose to fabricate a pet waste retrieval and storage system with a snap-on lid in lieu of a screw-on lid. Another example would include using metal fasteners such as snaps, as applicable, in lieu of certain hook and loop strip fasteners. Colors and sizes may vary. Such changes or modifications are numerous and may be made while not departing from the scope of the invention. Accordingly, it is intended that all matter contained in the above description or shown in the accompanying figures shall be interpreted as illustrative and not in a limiting sense or use.

I claim:

1. A pet waste retrieval system comprising:
a lightweight rigid container having a storage recess and an external opening that opens into the storage recess;
a removable lid for sealing the external opening, said removable lid including a first attachment means that seals the lid across the external opening and a second attachment means that couples the removable lid to the lightweight rigid container when the removable lid is not across the external opening;
a scoop that engages, encircles and lifts pet waste, said scoop being stored within the storage recess; and,
a cover coupled to an exterior surface of the lightweight rigid container, said cover including an attachment point between the exterior surface of the lightweight rigid container and the interior surface of the cover, the cover further comprises an axial fastener that fastens overlapping ends the cover together and onto the exterior surface of the lightweight rigid container and two circumferential fasteners that couple the cover to a strap attached to an animal.

2. The pet waste retrieval system of claim 1 wherein said lightweight rigid container comprises a plastic material.

3. The pet waste retrieval system of claim 2 wherein said lightweight rigid container is molded from one or more selected from a list consisting of polyvinyl chloride, polyethylene, polypropylene and polystyrene.

4. The pet waste retrieval system of claim 1 wherein said lightweight rigid container is formed from a thermo set or thermoplastic material having a threaded opening which is closable.

5. The pet waste retrieval system of claim 1 wherein said cover comprises two circumferential fasteners arranged on an exterior surface of the cover.

6. The pet waste retrieval system of claim 5 wherein said two circumferential fasteners comprise two strips of durable cloth material having lengths that exceed a length of the cover and that are sewn to the cover.

7. The pet waste retrieval system of claim 1 wherein said axial fastener comprises complementary strips of hook and loop material arranged at opposite ends of the cover on opposite sides thereof, such that when one end of the cover is overlapped onto the other end of the cover, the cover is fastened about an axial length of the exterior surface of the lightweight rigid container.

8. The pet waste retrieval system of claim 1 wherein said scoop comprises a plastic having a memory that causes the scoop to assume a curved cylindrical shape.

9. The pet waste retrieval system of claim 1 wherein said scoop comprises two ends that are saw-tooth in shape.

10. The pet waste retrieval system of claim 1 wherein said scoop comprises two straps arranged on an exterior surface of the scoop.

11. The pet waste retrieval system of claim 1 further comprising a plastic bag arranged around the scoop such that the scoop can encapsulate the pet waste within the bag.

12. A pet waste retrieval system comprising:
a lightweight rigid plastic container having a storage recess and an external opening that opens into the storage recess;
a removable lid for sealing the external opening, said removable lid including a first attachment means that seals the lid across the external opening and a second attachment means that couples the removable lid to the lightweight rigid container when the removable lid is not across the external opening;
a scoop that engages, encircles and lifts pet waste, said scoop being stored within the storage recess;
a plastic bag arranged around the scoop such that the scoop can encapsulate the pet waste within the bag; and,
a cover coupled to an exterior surface of the lightweight rigid container, said cover including an attachment point between the exterior surface of the lightweight rigid container and the interior surface of the cover, the cover further comprises an axial fastener that fastens overlapping ends of the cover together and onto the exterior surface of the lightweight rigid container and two circumferential fasteners that couple the cover to a strap attached to an animal; wherein said two circumferential fasteners comprise two strips of durable cloth material having lengths that exceed a length of the cover and that are sewn to the cover.

13. The pet waste retrieval system of claim 12 wherein said scoop comprises a plastic having a memory that causes the scoop to assume a curved cylindrical shape.

14. The pet waste retrieval system of claim 12 wherein said scoop comprises two ends that are saw-tooth in shape.

15. The pet waste retrieval system of claim 12 wherein said scoop comprises two straps arranged on an exterior surface of the scoop.

16. The pet waste retrieval system of claim 1 wherein said cover comprises two circumferential fasteners arranged on an exterior surface of the cover.

17. A method for retrieving pet waste comprising:
providing a pet waste retrieval system that includes a lightweight rigid container having a storage recess and an external opening into the storage recess; said pet waste retrieval system further includes a removable lid for sealing the external opening, said removable lid including a first attachment means that seals the lid across the external opening and a second attachment means that couples the removable lid to the lightweight rigid container when the removable lid is not across the external opening and, said pet waste retrieval system a cover coupled to an exterior surface of the lightweight rigid container;
removing the removable lid from the lightweight rigid container;
retrieving an empty bag and scoop from the lightweight rigid container;
attaching the scoop onto a hand of the user;
flattening out the hand to simultaneously open the scoop;
placing the hand and scoop into an empty bag;
arranging the bag, user's hand and scoop over the pet waste;
closing the user's hand and scoop such that the scoop subsequently encompasses the pet waste;
inverting the sides of the bag to encapsulated the pet waste within the bag;
removing the scoop from the user's hand;
sealing the bag;
returning the scoop to the storage recess;
placing the sealed bag, including the waste, back into the lightweight rigid container such that said scoop is arranged between a sidewall of the lightweight rigid container and an exterior surface of the sealed bag; and,
replacing the lid.

18. The method of claim 17 further comprising performing the plastic bag to a concave section of the scoop before retrieving the pet waste.

19. The method of claim 17 wherein said sealing includes wrapping a tie-wrap around an open end of the bag.

20. The method of claim 17 further comprising attaching the pet waste retrieval system onto a strap attached to a pet.
